(19) United States
(12) Patent Application Publication
(10) Pub. No.: US 2004/0251716 A1
(43) Pub. Date: Dec. 16, 2004

(54) Multistage impact absorption structure for a fender mounting part

(76) Inventors: In Ho Choi, Gunpo-si (KR); Ki Chang Kim, Suwon-si (KR)

Correspondence Address: MORGAN, LEWIS & BOCKIUS, LLP., 2 PALO ALTO SQUARE, 3000 EL CAMINO REAL, PALO ALTO, CA, 94306, US

(21) Appl. No.: 10/751,047

(22) Filed: Dec. 31, 2003

(30) Foreign Application Priority Data
Jun. 11, 2003 (KR) 2003-37619

(51) Int. Cl. B60J 5/00

(52) U.S. Cl. 296/187.03; 296/187.04

(57) ABSTRACT

The present invention relates to a connection structure of a fender and a hood of a vehicle. A vertical flange extending from the outer plate of the fender panel to the engine compartment is bent in a V-shape, and the inner apron panel forming the closed surface together with the outer apron panel of the fender upwardly extends in the longitudinal direction. An impact to the fender panel is first absorbed by deformation of the V-shaped flange and secondarily absorbed by an energy absorption space defined above an outer apron panel. Therefore, it is possible to minimize injury to a pedestrian when a pedestrian crashes with a vehicle.

### CROSS-REFERENCE TO RELATED APPLICATIONS

This application claims priority of Korean Application No. 10-2003-0037619, filed on Jun. 11, 2003, the disclosure of which is incorporated fully herein by reference.

### FIELD OF THE INVENTION

The present invention relates to a multistage impact absorption structure of a fender mounting part and, more particularly, to such a structure that is capable of first impact absorption by deformation when an impact is applied to a fender panel and is also capable of forming a second impact absorption space.

### BACKGROUND OF THE INVENTION

Generally, an engine compartment is provided at the front of a vehicle for mounting an apparatus and a system like an engine. The engine compartment is formed by a fender provided at both front sides of the vehicle body and a hood adapted to open and close the engine compartment.

Recently, there has been developed a vehicle body structure designed to satisfy various regulations enacted for passenger safety in the event of a car collision as well as pedestrian safety. Accordingly, organizations have been established to evaluate safety of a vehicle body based on various National Standards stipulating damage information with respect to each part of a pedestrian's body in the event of a collision.

Such organizations publish a damage level with respect to each part of a human body, such as a pedestrian's calf, knee, thigh and head. The damage level is computed based on a special computation method, so that customers can compare the safety among vehicles when they purchase a vehicle. Therefore, when a new vehicle is developed, the newly developed vehicle should comply with not only various related regulations, but also meet standards stipulated by the above-mentioned organizations.

For example, Japanese patent laid-open No. 2003-104240 discloses an impact absorption structure for a fender mounting part, wherein a bracket is installed in a vertical flange part of a fender at a certain interval. A resin collar is additionally installed at a portion of a vertical wall of the bracket for absorbing an impact. According to the Japanese patent laid-open No. 2003-89363, in a fender structure of a vehicle, a connection portion between a fender and an apron panel is formed by a combination of a vertical wall and a slanted wall for effectively absorbing impact energy without causing any damage of an outer layer of a fender. In addition, according to the Japanese patent No. 2001-334958, in a structure of a vehicle, a vertical flange is formed of an elastic unit for thereby enhancing a collision safety of a vehicle.

However, in conventional fender structures, impact from a pedestrian's head is not effectively absorbed when a vehicle crashes with a pedestrian (or at the time of a collision test of a head form) since a vertical flange extending from an outer layer to the engine compartment is formed in a shape of a straight line which is not easily bent. In the case that a pedestrian crashes into a running vehicle, as it is known from the collision test, a lower body of the pedestrian first crashes into the front side of the vehicle, and an upper body of the pedestrian is subsequently shifted up along the hood by the inertial force, so that the head second collides with the fender.

Typically, the prior art fender comprises a vertical flange that structurally has high strength, so that the fender is disadvantageous in deforming during a collision. In addition, it is impossible to obtain sufficient deformation space (for example, in the case of child, the space is about 50˜60 mm, and in the case of adults, the space is about 70˜80 mm, and in the conventional art, it is about 30˜40 mm) between the fender and the inner and outer side apron panels for decreasing pedestrian injury. Therefore, in the conventional art, the injury is increased by a high impact applied to the pedestrian's head.

FIG. 1 illustrates a relationship between such a prior art vertical flange and pedestrian injury (for example, children and adults) during a vehicle collision. As shown therein, in the conventional art, an additional impact energy absorption mechanism is needed.

### SUMMARY OF THE INVENTION

Embodiments of the present invention provide a multistage impact absorption structure for a fender mounting part in which a vertical flange extending from an outer layer of a fender panel to an engine compartment is bent in a V-shape. The length of an inner apron front panel forming a closed surface together with an outer apron panel of a fender is extended in an upward direction, so that a first impact absorption is achieved when an impact is applied to a fender panel (head form or pedestrian's head portion). When an impact is applied to a fender, a second impact absorption space is provided to absorb impact energy. Therefore, it is possible to minimize the degree of injury to a pedestrian's head when a pedestrian crashes with a vehicle, and the related regulations are satisfied.

### BRIEF DESCRIPTION OF THE DRAWINGS

The aforementioned aspects and other features of the present invention will be explained in the following description, taken in conjunction with the accompanying drawings, wherein:

FIG. 1 is a graph of a relationship between a vertical flange and a pedestrian damage level when a vehicle crashes in a conventional art;

FIG. 2 is a perspective view of a vehicle fender showing a location of structure according to an embodiment of the present invention.

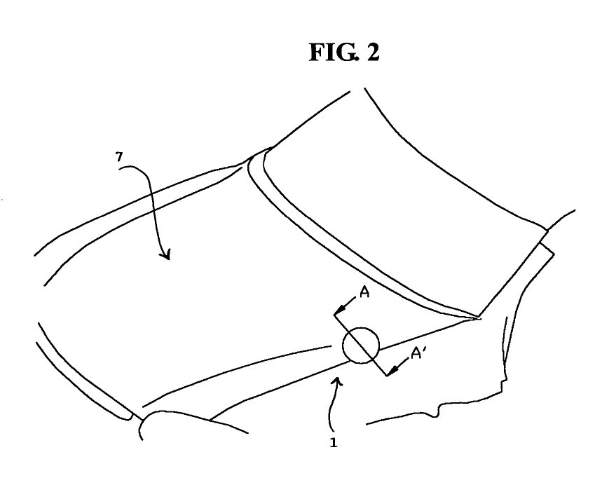

FIG. 3 is a cross sectional view taken along the line A-A of FIG. 2 and showing a multistage impact absorption structure of a fender mounting part according to the present invention; and

FIG. 4 is a comparison graph between the present invention and a conventional art with respect to a deceleration variation of a pedestrian protection test when an impact is applied to a head form.

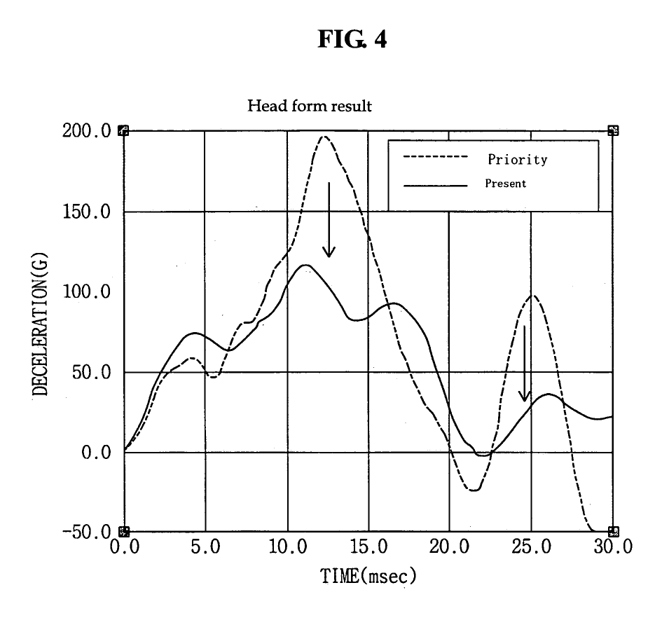

### DETAILED DESCRIPTION OF PREFERRED EMBODIMENTS

Hereinafter, such embodiments of the present invention are described in detail with reference to the accompanying drawings. The same elements as the descriptions of the conventional art will be given the same reference numerals in the drawings.

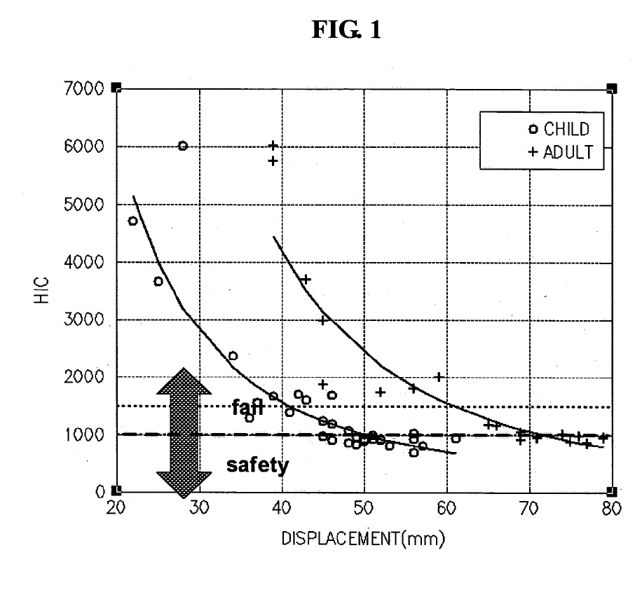

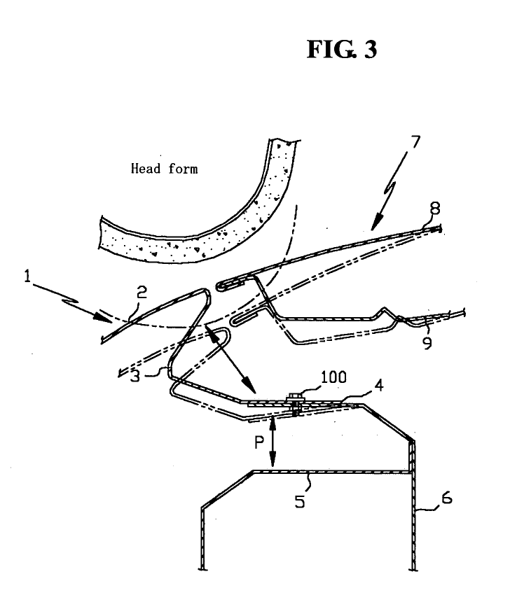

As shown in FIGS. 1 and 3, there is provided a fender 1 formed of an outer plate 2 forming an outer construction, vertical and horizontal flanges 3 and 4 bent in the direction from the outer plate 2 to the engine compartment, and inner and outer apron panels 6 and 5 forming the closed surface. There is further provided an outer panel 8 forming an outer construction for opening and closing the engine compartment, and an inner panel 9 integrally formed inside the outer panel 8. The vertical flange 3 is bent in V-shape for first absorbing an impact occurring due to deformation when an impact (head form or pedestrian's head) is applied to the fender 1. An upper side of the inner apron panel 6 is extended and engaged with the horizontal flange 4 by a fastener 100. A second impact absorption space P is formed between the outer side apron panel 5 and the horizontal flange 4 by the above engagement.

Thus, the impact energy firstly absorbed by the V-shaped bent portion of the vertical flange 3 is secondly absorbed by the lower portion of the horizontal flange 4. Secondary energy absorption is assisted by a partly angled member that joins the horizontal flange 4 with outer apron panels 5 and 6 just to the right of fastener 100 in the drawing.

The operation according to an embodiment of the present invention will be described with reference to the accompanying drawings. Therefore, when a front side or a lateral side of the running vehicle crashes with a pedestrian, the impact energy is first absorbed by a deformation of the vertical flange 3 vertically bent in V shape. In addition, the absorption space P formed by the inner and outer apron panels 6 and 5 secondarily absorbs the impact energy first absorbed by a deformation of the vertical flange 3. Therefore, in the present invention, it is possible to minimize the injury applied to the head of a pedestrian when the vehicle crashes with a pedestrian.

In other words, when a certain impact is applied to the fender 1, the impact energy is sequentially absorbed by the bent construction of the vertical flange 3 and the absorption space P formed between the inner and outer apron panels 6 and 5. As shown in the comparison graph of FIG. 6, in the present invention, it is possible to more effectively decrease the impact force applied to the pedestrian as compared to the conventional art, so that it is possible to significantly decrease the damages to be delivered to the pedestrians.

As described above, in the present invention, the vertical flange extended from the outer plate of the fender panel to the engine compartment is bent in V shape, and the inner apron panel forming the closed surface together with the outer apron panel of the fender is upwardly extended in the longitudinal direction. In the above state, when there is an impact to the fender panel (head form or pedestrian's head), the first impact absorption is guided, and when an impact is applied to the fender, the second impact energy absorption space with respect to the impact is provided. Therefore, it is possible to minimize the damages applied to the pedestrian's head when the pedestrian crashes with the vehicle. The regulations of the related laws are satisfied in the present invention.

What is claimed is:

1. A multistage absorption structure of a fender mounting part comprising:
a fender having an outer plate forming an outer construction, vertical and horizontal flanges inwardly bent toward an engine compartment, and inner and outer apron panels forming a closed surface; and
a hood having an outer panel and an inner panel integrally formed with the outer panel, wherein:
said vertical flange is V-shaped for firstly absorbing an impact by deformation when an impact is applied to the fender; and
an impact absorption space is formed between said horizontal flange and said outer apron panel in such a manner that an upper side of said inner apron panel is extended and engaged with said horizontal flange, whereby the impact energy firstly absorbed by the V-shaped bent portion of said vertical flange is secondly absorbed by the lower portion of said horizontal flange.

2. A multistage absorption structure, including a fender portion comprising an outer plate with a sideways V-shaped vertical flange extending inward therefrom and joining with a horizontal flange, an outer apron panel being positioned below said horizontal flange to define a secondary energy absorption space therebetween, primary energy absorption being achieved by said V-shaped vertical flange.

3. The multistage absorption structure of claim 2, further including a hood portion adjacently disposed with respect to the fender portion and comprising an outer panel formed with an inner panel.

4. The multistage absorption structure of claim 2, wherein said outer apron panel is joined with said horizontal flange by a partly angled member joined with a vertical inner apron panel to define an end of said secondary energy absorption space.
